(19) United States
(12) Patent Application Publication
(10) Pub. No.: US 2019/0138952 A1
(43) Pub. Date: May 9, 2019

(54) APPARATUS FOR PROVIDING VEHICLE SHARING SERVICE, SYSTEM INCLUDING THE SAME, AND METHOD THEREOF

(71) Applicants: Hyundai Motor Company, Seoul (KR); Kia Motors Corporation, Seoul (KR)

(72) Inventors: Ji Min HAN, Anyang-si (KR); Anastasia Yarygina, Seoul (KR); Jung Mi Park, Anyang-si (KR); Ji A Lee, Uiwang-si (KR)

(73) Assignees: Hyundai Motor Company, Seoul (KR); Kia Motors Corporation, Seoul (KR)

(21) Appl. No.: 15/973,791

(22) Filed: May 8, 2018

(30) Foreign Application Priority Data
Nov. 8, 2017 (KR) 10-2017-0148073

(51) Int. Cl. G06Q 10/02; G06Q 30/02

(52) U.S. Cl. CPC G06Q 10/02; G06Q 30/0283

(57) ABSTRACT

An apparatus for providing a vehicle sharing service, a system including the same, and a method thereof, may include setting a vehicle sharing service mode through a vehicle terminal or a user terminal to protect private information and provide a user customized vehicle sharing service.

### CROSS-REFERENCE TO RELATED APPLICATION

The present application claims priority to Korean Patent Application No. 10-2017-0148073, filed on Nov. 8, 2017, in the Korean Intellectual Property Office, the entire contents of which is incorporated herein for all purposes by this reference.

### BACKGROUND OF THE INVENTION

### Field of the Invention

The present invention relates to an apparatus configured for providing a vehicle sharing service, a system including the same, and a method thereof, and more particularly to a technology of setting a vehicle sharing service mode through a vehicle terminal or a user terminal to protect private information and provide a user customized vehicle sharing service.

### Description of Related Art

In recent years, due to traffic jam and increase of the oil prices, vehicle sharing services for renting vehicles or using one vehicle by several persons instead of using their own vehicles have been widely used.

In order to provide the vehicle sharing service, a separate terminal for the vehicle sharing service is installed in the vehicle, the vehicle sharing service is executed through an internal communication modem, and the system is updated.

However, when the user gets off the vehicle after using the vehicle sharing service, private information such as a vehicle setting value set in the vehicle and driving information related to the vehicle are left in the vehicle so that the private vehicle is exposed to the next user or the vehicle owner.

Furthermore, the next user or the vehicle owner has to set his or her vehicle setting value after separately initializing the information related to the previous user, and unnecessary information continues to be provided in spite that he or she does not want to identify the private information related to the previous user.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus configured for providing a vehicle sharing service by which private information related to a vehicle sharing service provider and a vehicle sharing service user may be protected by setting a vehicle sharing service mode through an application of a vehicle terminal device or a mobile communication terminal to limit functions of a vehicle according to costs and a request for the vehicle sharing service provider.

The technical objects of the present invention are not limited to the above-mentioned one, and the other unmentioned technical objects will become apparent to those skilled in the art from the following description.

In accordance with an aspect of the present invention, there is provided an apparatus configured for providing a vehicle sharing service, the apparatus including a reservation device configured to accept a reservation for a vehicle sharing service from a user terminal for use of the vehicle sharing service, to request an approval of the reservation from a provider terminal of a provider of the vehicle, the reservation of which has been accepted, and to, if the approval of the reservation is received from the provider terminal, confirm the reservation, and a private information protecting device configured to provide a vehicle setting value received from the user terminal to the vehicle, the reservation of which has been accepted, and to request initialization of the vehicle setting value from the vehicle after the use of the vehicle sharing service of the vehicle is completed.

The private information protecting device may include a vehicle setting value transmitting device configured to, if the vehicle setting value is received from the user terminal, transmit the vehicle setting value to the vehicle, the reservation of which has been accepted, a vehicle setting value initializing device configured to, if the vehicle is returned after the vehicle sharing service is provided through the vehicle, request initialization of the setting of the vehicle setting value and deletion of vehicle sharing service use information, and a personalization device configured to, if the vehicle is returned, encrypt the vehicle sharing service use information including the vehicle setting value.

The reservation device may include a reservation accepting device configured to, if a request for a reservation for a vehicle sharing service is accepted from the user terminal, receive a use date and a use time from the user terminal, a vehicle list generating device configured to generate a list of vehicles that may be reserved at the use date and the use time, a reservation approval requesting device configured to, if one of the vehicles in the list is selected, request an approval of the reservation from the provider terminal of the provider of the selected vehicle, and a reservation confirming device configured to, if the approval of the reservation is completed, confirm the reservation.

The apparatus may further include a charging policy device configured to determine costs for the vehicle sharing service according to the vehicle setting value.

The vehicle sharing service use information may include at least one of a vehicle setting value, user information, vehicle driving information, total driving distance information, and reservation time information, the user information may include at least one of a name and driving license information related to a user who reserved the vehicle sharing service, the vehicle driving information may include at least one of a vehicle driving route and accident location information, and the reservation time information may include at least one of a rent time, a reservation start time, a reservation expiration time, and a vehicle return time.

The personalization device may provide, among the vehicle sharing service use information, the user information, the vehicle setting value, and the reservation time information to the provider terminal, and may not provide the vehicle driving information and the total driving distance information to the provider terminal.

The apparatus may further include a monitoring device configured to, when the vehicle sharing service is provided through the vehicle, monitor a vehicle driving item.

The monitoring device may monitor whether the vehicle that provides the vehicle sharing service encounters an accident, and may transmit the user information and the vehicle driving information to the provider terminal when the vehicle encounters an accident.

The monitoring device may identify whether the user is in the vehicle if the reservation start time of the vehicle comes, and may identify whether the vehicle is returned if the reservation expiration time of the vehicle comes.

The apparatus may further include a notification device configured to transmit a notification notifying whether the user is in the vehicle to the provider terminal after the reservation start time of the vehicle comes, and to transmit a notification to the provider terminal when an accident occurs during driving of the vehicle or the vehicle is not returned even though the reservation expiration time of the vehicle comes.

The vehicle setting value may be a setting value of at least one of an occupant classification system (OCS), a side airbag, a heating wire sheet, a steering wheel heater, a riding posture memory system, a Hi-Pass system, a head-up display, a parking assistant system, an around view monitoring (AVM) device, a portable phone wireless charging system, a blue link, an adaptive control suspension, a drive mode (eco/normal/sport), a rear warning system, an advanced smart cruise control (ASCC), an HAD highway driving support system, and a lane keeping assist system (LKAS).

The user terminal or the provider terminal may include a mobile communication terminal or a vehicle terminal mounted in the vehicle.

In accordance with various exemplary embodiments of the present invention, there is provided a system for providing a vehicle sharing service, the system including a processor configured to accept a reservation for a vehicle sharing service from a user terminal for use of the vehicle sharing service, and to, if an approval of the reservation is received from a provider terminal of a provider of a vehicle, the reservation of which has been accepted, confirm the reservation, to transmit a vehicle setting value received from the user terminal to the vehicle, the reservation of which has been accepted, to, if the vehicle is returned after the vehicle sharing service is provided through the vehicle, request initialization of the setting of the vehicle setting value and deletion of vehicle sharing service use information, and to encrypt the vehicle sharing service use information including the vehicle setting value, and a storage configured to store the encrypted vehicle sharing service use information for users.

The processor may include a reservation device configured to accept a reservation for a vehicle sharing service from a user terminal for use of the vehicle sharing service, to request an approval of the reservation from a provider terminal of a provider of the vehicle, the reservation of which has been accepted, and to if the approval of the reservation is received from the provider terminal, confirm the reservation, a vehicle setting value transmitting device configured to, if the vehicle setting value is received from the user terminal, transmit the vehicle setting value to the vehicle, the reservation of which has been accepted, a vehicle setting value initializing device configured to, if the vehicle is returned after the vehicle sharing service is provided through the vehicle, request initialization of the setting of the vehicle setting value and deletion of vehicle sharing service use information, a charging policy device configured to determine costs for the vehicle sharing service according to the vehicle setting value, and a personalization device configured to, if the vehicle is returned, encrypt the vehicle sharing service use information.

The system may further include a communication device configured to perform communication with the user terminal or the provider terminal, and an authentication device configured to perform authentication when a request for login is made by the user terminal or the provider terminal.

In accordance with various exemplary embodiments of the present invention, there is provided a method for providing a vehicle sharing service, the method including accepting a reservation for a vehicle sharing service from a user terminal of a vehicle sharing user for a vehicle, requesting an approval of a reservation from a provider terminal of a provider, the reservation of which has been accepted, if the approval of the reservation is received from the provider terminal, transmitting a vehicle setting value to the vehicle, the reservation of which has accepted, if the vehicle is returned after the vehicle sharing service is provided through the vehicle, requesting initialization of the setting of the vehicle setting value and deletion of vehicle sharing service use information, and storing the vehicle sharing service use information including the vehicle setting value for users.

The method may further include, when a request for login is made by an application executed in the user terminal, performing authentication.

The method may further include storing vehicle sharing service use information including the vehicle setting value for users, and encrypting and storing the vehicle sharing service use information.

The accepting of the reservation for the vehicle sharing service may include, if the request for the reservation of the vehicle sharing service is accepted from the user terminal, receiving a use date and a use time from the user terminal and generating a list of vehicles that may be reserved at the use date and the use time, providing the list of the vehicles to the user terminal, and selecting a vehicle by the user terminal and receiving a vehicle setting value.

The method may further include determining costs for the vehicle sharing service according to the vehicle setting value.

The method may further include, if the reservation is confirmed, requesting payment of costs from the user terminal.

The method may further include, when the vehicle sharing service is provided through the vehicle, monitoring a vehicle driving item.

The monitoring of the vehicle driving item may include when the vehicle encounters an accident, transmitting use information and vehicle driving information to the provider terminal.

The vehicle sharing service use information may include at least one of a vehicle setting value, user information, vehicle driving information, total driving distance information, and reservation time information, the user information may include at least one of a name of a user who reserved the vehicle sharing service and driving license information, the vehicle driving information may include at least one of a vehicle driving route and accident location information, and the reservation time information may include at least one of a rent time, a reservation start time, a reservation expiration time, and a vehicle return time.

Among the vehicle sharing service use information, the user information, the vehicle setting value, and the reservation time information may be provided to the provider terminal, and the vehicle driving information and the total driving distance information may not be provided to the provider terminal.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a system for providing a vehicle sharing service according to an exemplary embodiment of the present invention;

FIG. 2A is a block diagram of a detailed configuration of a private information protecting device of FIG. 1;

FIG. 2B is a block diagram of a detailed configuration of a reservation device of FIG. 1;

FIG. 3 is a sequence diagram illustrating a method for providing a vehicle sharing service according to an exemplary embodiment of the present invention;

FIG. 4 is a sequence diagram illustrating a reservation method for providing a vehicle sharing service in detail according to an exemplary embodiment of the present invention;

FIG. 5 is a flowchart illustrating operations of a system for providing a vehicle sharing service in detail according to an exemplary embodiment of the present invention;

FIG. 6 is an exemplary view of a service mode selecting screen according to an exemplary embodiment of the present invention; and

FIG. 7 is a diagram of a computer system to which the method for providing a vehicle sharing service according to an exemplary embodiment of the present invention is applied.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, various exemplary embodiments of the present invention will be described more specifically with reference to the accompanying drawings. Throughout the specification, it is noted that the same or like reference numerals denote the same or like components even though they are provided in different drawings. Furthermore, in the following description of the present invention, a detailed description of known functions and configurations incorporated herein will be omitted when it may make the subject matter of the present invention rather unclear.

Furthermore, terms, such as first, second, A, B, (a), (b) or the like may be used herein when describing components of the present invention. The terms are provided only to distinguish the elements from other elements, and the essences, sequences, orders, and numbers of the elements are not limited by the terms. Furthermore, unless defined otherwise, all terms used herein, including technical or scientific terms, have the same meanings as those generally understood by those skilled in the art to which the present invention pertains. The terms defined in the generally used dictionaries should be construed as having the meanings that coincide with the meanings of the contexts of the related technologies, and should not be construed as ideal or excessively formal meanings unless clearly defined in the specification of the present invention.

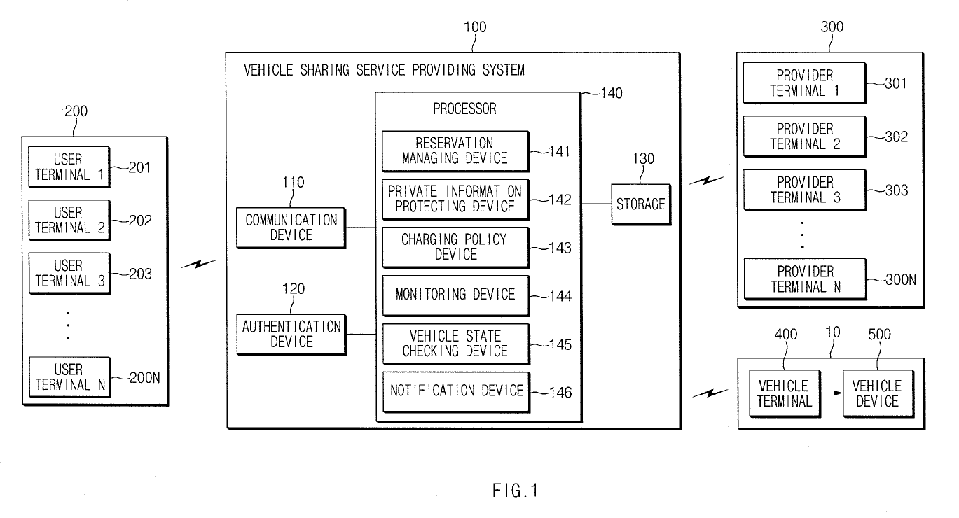

Hereinafter, various exemplary embodiments of the present invention will be described more specifically with reference to FIGS. 1 to 7.

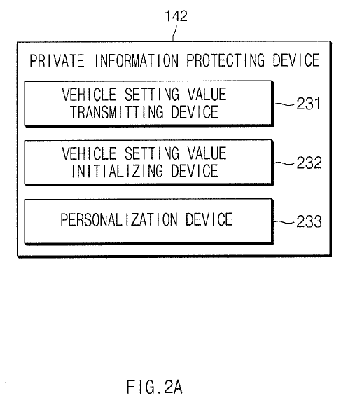

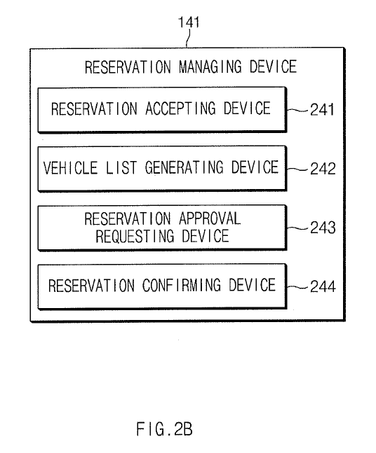

FIG. 1 is a block diagram illustrating a system for providing a vehicle sharing service according to an exemplary embodiment of the present invention. FIG. 2A is a block diagram of a detailed configuration of a private information protecting device of FIG. 1. FIG. 2B is a block diagram of a detailed configuration of a reservation device of FIG. 1.

Referring to FIG. 1, the system 100 for providing a vehicle sharing service according to the embodiment of various aspects of the present invention provide a vehicle sharing service between a user terminal group 200 and a provider terminal group 300.

A plurality of user terminals 201, 202, . . . , and 200N are terminals that are used by users who desire to move to destinations by use of a vehicle sharing service, and a plurality of provider terminals 301, 302, . . . , and 300N are terminals of providers who provide vehicles to the users.

The plurality of user terminals 201, 202, . . . , and 200N and the plurality of provider terminals 301, 302, . . . , and 300N may include all mobile communication terminals including smartphones, pads, and PDAs, which are portable, and vehicle terminals including navigation devices, audio, video, navigation (AVN) devices, telematics devices, and clusters, which are mounted on the vehicles.

Furthermore, an application for receiving a vehicle sharing service may be installed in the plurality of user terminals 201, 202, . . . , and 200N and the plurality of provider terminals 301, 302, . . . , and 300N and the application is executed such that the vehicle sharing service may be provided.

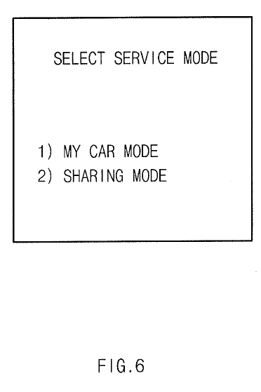

The plurality of provider terminals 301, 302, . . . , and 300N may select service modes when the application is executed. FIG. 6 is an exemplary view of a service mode selecting screen according to an exemplary embodiment of the present invention. As in FIG. 6, a provider may select one of a my car mode in which the provider directly drives the vehicle and a sharing mode in which the provider rents the vehicle. A vehicle setting value stored in advance is applied according to the selected mode so that devices in the vehicle may be set. For example, when the my car mode is selected, the vehicle setting value set by the provider is applied, and if the sharing mode is selected, the vehicle setting value of the previous provider is initialized and is set to a vehicle setting value of the user who requests a reservation.

The system 100 for providing a vehicle sharing service includes a communication device 110, an authentication device 120, a storage 130, and a processor 140.

The communication device 110 performs communication with the plurality of user terminals 201, 202, . . . , and 200N, the plurality of provider terminals 301, 302, . . . , and 300N, and the vehicle terminal 400.

When the plurality of user terminals 201, 202, . . . , and 200N and the plurality of provider terminals 301, 302, . . . , and 300N log in, the authentication device 120 logs in after performing authentication by use of the authentication information stored in advance. As such, the plurality of user terminals 201, 202, . . . , and 200N may reserve a vehicle for using a vehicle sharing service by registering a membership through the application and logging in, and the plurality of provider terminals 301, 302, . . . , and 300N may identify reservation information, vehicle driving information, user information, and the like by registering a membership and logging in. As such, the user information includes at least one of the name of the user who reserved a vehicle sharing service and a driving license information, and the vehicle driving information may include at least one of a vehicle driving route, vehicle accident location information, and a vehicle driving distance.

The storage 130 may store location information related to the plurality of user terminals 201, 202, . . . , and 200N and the plurality of provider terminals 301, 302, . . . , and 300N that are registered, map information for generating a route, traffic information, route information to a destination, user authentication information, route information, vehicle sharing platform information, a vehicle sharing service, or vehicle call service charging policy information.

The processor 140 accepts a reservation of a vehicle sharing service from a user terminal for use of the vehicle sharing service, confirms the reservation if an approval for the reservation is received from the provider terminal of the provider of the vehicle, the reservation of which has been accepted, transmits the vehicle setting value received from the user terminal to the vehicle, the reservation of which has been accepted, requests initialization of the setting of the vehicle setting value from the vehicle if the vehicle is returned after the vehicle sharing service is provided through the vehicle, and encrypts the vehicle setting value.

To achieve this, the processor 140 includes a reservation device 141, a private information protecting device 142, a charging policy device 143, a monitoring device 144, a vehicle state checking device 145, and a notification device 146.

The reservation device 141 accepts a reservation for a vehicle sharing service from a user terminal for use of the vehicle sharing service, requests an approval of the reservation from the provider terminal of the provider of the vehicle, the reservation of which has been accepted, and confirms the reservation if the approval of the reservation is received from the provider terminal. Referring to FIG. 2B, in a detailed description of the configuration of the reservation device 141, the reservation device 141 includes a reservation accepting device 241, a vehicle list generating device 242, a reservation approval request device 243, and a reservation confirming device 244.

If a request for a reservation for a vehicle sharing service is accepted from the user terminal, the reservation accepting device 241 receives a use date and a use time from a user terminal.

The vehicle list generating device 242 generates a list of vehicles that may be reserved at the use date and the use time input from the user terminal.

If one of the vehicles in the list of vehicles is selected, the reservation approval requesting device 243 requests an approval of the reservation from the provider terminal of the provider of the selected vehicle.

If the approval of the reservation from the provider terminal is completed, the reservation confirming device 244, the reservation confirming device 244 finally confirms the reservation.

The private information protecting device 142 transmits a vehicle setting value to the vehicle, the reservation of which has been accepted if receiving the vehicle setting value from the user terminal, and requests initialization of the vehicle setting value and deletion of the vehicle sharing service use information if the vehicle is returned after the vehicle sharing service is completed.

Referring to FIG. 2A, the private information protecting device 142 includes a vehicle setting value transmitting device 231, a vehicle setting value initializing device 232, and a personalization device 233.

If receiving a vehicle setting value from the user terminal, the vehicle setting value transmitting device 231 transmits the received vehicle setting value to the vehicle 10, the reservation of which has been accepted. As such, the vehicle terminal 400 in the vehicle 10 receives the vehicle setting value and applies the received vehicle setting value to the vehicle device 500.

As such, the vehicle device 500 may be at least one of an occupant classification system (OCS), a side airbag, a heating wire sheet, a steering wheel heater, a riding posture memory system, a Hi-Pass system, a head-up display, a parking assistant system, an around view monitoring (AVM) device, a portable phone wireless charging system, a blue link, an adaptive control suspension, a drive mode (eco/normal/sport), a rear warning system, an advanced smart cruise control (ASCC), an HAD highway driving support system, and a lane keeping assist system (LKAS), and the vehicle setting value may include a setting value for the vehicle device 500. Although FIG. 1 disclosers an example of one vehicle 10, the present invention is not limited to one vehicle 10, but all vehicles owned by the providers may be targets for the vehicle sharing service.

If the vehicle sharing service is provided through the vehicle and then the vehicle is returned, the vehicle setting value initializing device 232 may request initialization of the setting value of the vehicle and deletion of the vehicle sharing service use information from the vehicle. As such, the vehicle sharing service use information may include at least one of a vehicle setting value, user information, vehicle driving information, total driving distance information, and reservation time information. The user information may include at least one of the name of the user who reserved the vehicle sharing service and driving license information, the vehicle driving information may include at least one of a vehicle driving route and vehicle accident location information, and the reservation time information may include at least one of a rent time, a reservation start time, a reservation expiration time, and a vehicle return time.

The personalization device 233 encrypts vehicle sharing service use information, and stores the information encrypted for the users in the storage 130. Accordingly, when the user reserves the same vehicle again later even if the vehicle setting value in the vehicle that provided the vehicle sharing service is deleted, the private information related to the user may be protected and the user customized vehicle setting may be conveniently made by setting the vehicle setting value stored in advance in the reserved vehicle.

Furthermore, the personalization device 233 may provide the encrypted vehicle sharing service use information to the user terminal, and may provide, among the vehicle sharing service use information, the user information (the name, the resident registration number of the user, and the like), the vehicle setting value (a convenience specification, a function, and the like), and reservation time information to the provider terminal to allow the provider to identify them. As such, the personalization device 233 may not provide, among the vehicle sharing service use information, the vehicle driving information (the destination, the route, and the location), the driving distance, and the like to the provider terminal to protect the private information related to the user.

The charging policy device 143 determines vehicle sharing service costs due to the vehicle setting value (including a convenience specification selection value), and requests payment of the corresponding costs form the user terminal after determining the costs for the vehicle sharing service and additional costs according to the selection of the convenience specification. Table 1 is an exemplary table for selection of costs according to a vehicle setting value (selection of a convenience specification).

TABLE 1

| Model | | | Selected |
|---|---|---|---|
| of vehicle | Specification | Additional sum | specification |
| Model 1 | Navigation device | 3000 Won | |
| | LKAS (Lane Keeping | 3000 Won | V |
| | Assist System) | | |
| | HUD (Head up display) | 3000 Won | |
| | AVM (Around view | 3000 Won | V |
| | monitoring) system | | |
| | Wireless charging | 5000 Won | V |
| | device | | |
| | Hi-Pass system | 0 Won | V |

Referring to Table 1, the user selects the LKAS, the AVM, the wireless charging device, and a Hi-Pass system from the convenience specifications including the navigation device, the LKAS, the HUD, the AVM, the wireless charging device, and the Hi-Pass system. That is, as the user selects more convenience specifications, the costs increase.

When the vehicle sharing service is provided through the vehicle, the monitoring device 144 monitors a vehicle driving item. Furthermore, the monitoring device 144 monitors whether the vehicle that provides the vehicle sharing service encounters an accident, and when the vehicle encounters an accident, transmits user information and vehicle driving information to the provider terminal. As such, it may be determined whether an accident occurs, by use of the checking result of the vehicle state checking device 145.

If the reservation start time of the vehicle comes, the monitoring device 144 may identify whether the user is in the vehicle, and if the reservation expiration time of the vehicle comes, it may be identified whether the vehicle is returned. As such, it may be determined whether the user is in the vehicle or the vehicle is returned, by use of the checking result of the vehicle state checking device 145. As such, it may be determined whether the user is in the vehicle by use of various methods, for example, by starting on the vehicle before and after the reservation start time or getting on the vehicle and sending a getting-on completion text message to the system of providing a vehicle sharing service. It may be determined whether the vehicle has been returned by determining whether the vehicle is located at a specific site or by receiving a return confirming text message from the user. Meanwhile, the method for determining whether the user is in the vehicle or the vehicle has been returned is not limited to the included methods, and may be accomplished through various general methods.

The vehicle state checking device 145 receives all vehicle related information including a current location (GPS) of the vehicle, driving information related to the vehicle, air pressures of the tires of the vehicle, and engine oil information, through communication with the vehicle terminal 400, and checks a state of the vehicle. Furthermore, the vehicle state checking device 145 determines whether an accident occurs by detecting a change of the vehicle including an operation of the airbag due to collision of the vehicle. Furthermore, the vehicle state checking device 145 detects whether the user is accommodated on the seat of the vehicle (by use of a weight detector or the like) and delivers the result to the monitoring device 144, and the monitoring device 144 may determine whether the user gets on or off the vehicle according to whether the user is accommodated on the seat. In the present way, the vehicle state checking device 145 transmits and receives information by which the state of the internal of the vehicle may be recognized, through communication with the vehicle terminal 400 of the vehicle 10.

The notification device 146 transmits a notification that notifies whether the user is in the vehicle after the reservation start time of the vehicle comes to the provider terminal, and transmits a notification to the provider when the vehicle is not returned even though an accident occurred during driving of the vehicle or a reservation expiration time of the vehicle comes. For example, when 30 minutes or more elapses from the reservation start time or the reservation return time or the vehicle is not returned until 10 minutes before the next reservation, the provider terminal may be notified of a notification text message or a notification of an application. Furthermore, the notification device 146 may transmit a notification through transmission of a text message or a notification of an application.

In the present way, according to an exemplary embodiment of the present invention, a reservation for a vehicle sharing service may be accepted or approved and a service mode including a sharing mode, may be selected through a mobile communication terminal including a vehicle terminal or a smartphone, vehicle setting values for users may be automatically set in the sharing mode, private information may be protected by deleting all vehicle sharing service use information (a vehicle setting value, user information, vehicle driving information, vehicle specification information, vehicle reservation time information, and a total driving distance) of the user in the vehicle if the vehicle sharing service is completed and the vehicle is returned, and the convenience of the user may be enhanced by setting a vehicle setting value which is stored in advance when the same vehicle is reserved by the user again after the vehicle sharing service use information related to the user is encrypted and stored in the vehicle sharing service providing system 100 to the reserved vehicle.

Furthermore, the present invention may transmit a vehicle setting value from a remote site to the vehicle that provides a vehicle sharing service and may perform a remote control such that the vehicle setting value is applied to the vehicle device.

Furthermore, needs of the user may be satisfied by allowing the user to select a convenience specification of the vehicle according to the purpose of the user and to additionally pay only a fee according to the selected convenience specification, and the satisfaction of the user may be increased by paying a reasonable fee.

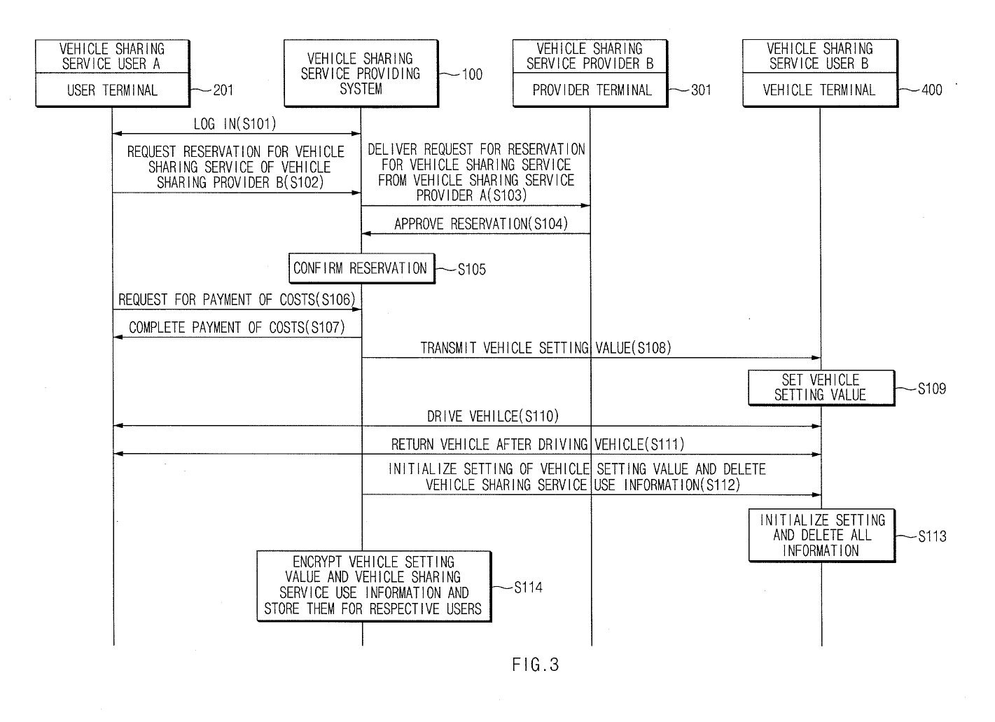

Hereinafter, the method for providing a vehicle sharing service according to an exemplary embodiment of the present invention will be described more specifically with reference to FIG. 3. FIG. 3 is a sequence diagram illustrating a method for providing a vehicle sharing service according to an exemplary embodiment of the present invention.

Referring to FIG. 3, if an application for providing a vehicle sharing service is executed in a user terminal 201 of vehicle sharing service user A and a login is requested by the user terminal 201, an authentication is performed and a login is performed (S101). The, the user terminal 201 may be a mobile communication terminal of vehicle sharing service user A.

If receiving a reservation of a vehicle sharing service of the vehicle of vehicle sharing service provider B from the user terminal 201 (S102), the vehicle sharing service providing system 100 delivers the request for the reservation of the vehicle sharing service of vehicle sharing service user A to the provider terminal 301 of vehicle sharing service provider B (S103). As such, the provider terminal 301 may be a mobile communication terminal or a vehicle terminal of vehicle sharing service provider B. As such, the vehicle terminal may include a vehicle terminal 400 that applies or initializes the vehicle setting value.

If receiving an approval of a reservation from the provider terminal 301 of vehicle sharing service provider B (S104), the vehicle sharing service providing system 100 confirms the reservation between vehicle sharing service user A and vehicle sharing service provider B (S105).

Thereafter, the vehicle sharing service providing system 100 requests vehicle sharing service use costs for the reservation and costs according to the selection of the convenience specification of the vehicle from the user terminal 201 of vehicle sharing service user A (S106).

Accordingly, if the user terminal 201 completely pays costs (S107), the vehicle sharing service providing system 100 transmits the vehicle setting value received from the user terminal 201 during the reservation to the vehicle terminal 400 of vehicle sharing service provider B (S108). Accordingly, the vehicle terminal 400 applies the vehicle setting value to the vehicle device 500 (S109).

Thereafter, if the reservation start time comes, vehicle sharing service user A gets on the vehicle, to which the vehicle setting value is set, to drive the vehicle (S110), and if the reservation expiration time comes and the vehicle is returned (S111), the vehicle sharing service providing system 100 requests initialization of the setting of the vehicle setting value and deletion of the vehicle sharing service use information from the vehicle terminal 400 of vehicle sharing service provider B (S112). As such, the vehicle sharing service use information may include user information (the name and the resident registration number of the user and the like), vehicle driving information (a driving route or a location of the vehicle), vehicle reservation time information (a reserved rent time, a reservation start time, a reservation expiration time, a return time, and the like), a vehicle setting value, a total driving distance, and the like).

Accordingly, the vehicle terminal 400 initializes setting of the vehicle setting value and deletes the vehicle sharing service use information (S113).

Thereafter, the vehicle sharing service providing system 100 encrypts the vehicle setting value and the vehicle sharing service use information and stores them for respective users (S114).

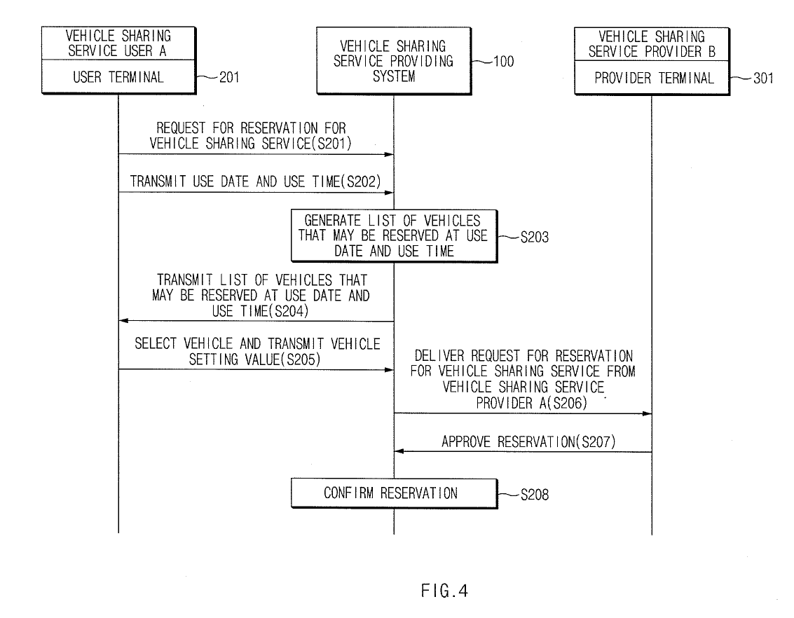

Referring to FIG. 4, a sequence diagram illustrating a reservation method for providing a vehicle sharing service according to an exemplary embodiment of the present invention will be described more specifically. FIG. 4 is a sequence diagram illustrating a reservation method for providing a vehicle sharing service more specifically according to an exemplary embodiment of the present invention.

If receiving a request for a reservation for a vehicle sharing service from a user terminal 202 of vehicle sharing service user A (S201), the vehicle sharing servicer providing system 100 receives a use date and a use time for a reservation from the user terminal 201 of vehicle sharing service user A (S202).

The vehicle sharing service providing system 100 generates a list of vehicles that may be reserved at a user date and a use time (S203). As such, the list of vehicles may be a list of vehicles of the providers who registered memberships.

Subsequently, the vehicle sharing service providing system 100 transmits the list of vehicles that may be reserved at the generated use date and the use time to the user terminal 201 of vehicle sharing service user A (S204).

Vehicle sharing service user A selects a desired vehicle from the list of vehicles displayed on the user terminal 201, and inputs a convenience specification (a vehicle setting value) of the selected vehicle.

Accordingly, the vehicle sharing service providing system 100 receives a vehicle selected by the user terminal 201 and an input vehicle setting value (S205), and delivers a request for a reservation of a vehicle sharing service from vehicle sharing service user A (S206).

If the reservation is approved by the provider terminal 301 of vehicle sharing service provider B (S207), the vehicle sharing service providing system 100 confirms the reservation (S208).

In the present way, the present invention may enhance the convenience of the user by allowing the user to directly select a vehicle when a vehicle sharing service is reserved and to select a convenience specification (a vehicle setting value) of the vehicle.

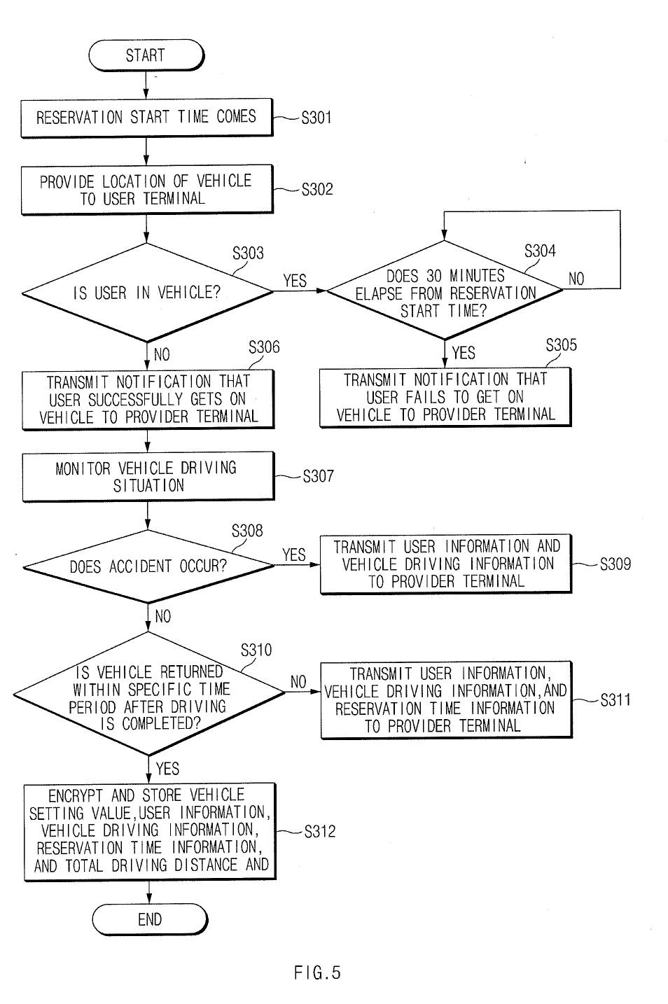

Referring to FIG. 5, operations of a system for providing a vehicle sharing service according to an exemplary embodiment of the present invention will be described. FIG. 5 is a flowchart illustrating operations of a system for providing a vehicle sharing service more specifically according to an exemplary embodiment of the present invention. A process performed after the reservation for the vehicle sharing service is confirmed will be described more specifically with reference to FIG. 3.

Referring to FIG. 5, the vehicle sharing service providing system 100 provides a location of the vehicle if a reservation start time comes (S302).

The vehicle sharing service providing system 100 monitors whether the user is in the vehicle (S303), when the user is not in the vehicle at the reservation start time, checks whether 30 minutes elapses from the reservation start time (S304), and if the 30 minutes elapses from the reservation start time, transmits a notification that notifies that the user fails to get on the vehicle to the provider terminal 301 (S305).

Meanwhile, when it is determined that the user is in the vehicle in operation S303, the vehicle sharing service providing system 100 transmits a notification that the user successfully gets on the vehicle to the provider terminal (S306).

Thereafter, the vehicle sharing service providing system 100 monitors a vehicle driving situation (S307), checks whether an accident occurs (S308), and transmits user information (the name and the resident registration number and the like) and vehicle driving information (a route and a current location of the vehicle) (S309).

Meanwhile, the vehicle sharing service providing system 100 identifies whether the vehicle is returned in a specific time period after the driving of the vehicle is completed without generating an accident (S310), and transmits user information, vehicle driving information, and reservation time information to the provider terminal 301 when the vehicle is not returned (S311).

Meanwhile, when the vehicle is returned within a specific time period after the driving of the vehicle is completed, the vehicle sharing service providing system 100 encrypts and stores a vehicle setting value and vehicle sharing service use information (user information, vehicle driving information, reservation time information, a driving distance, and the like) (S312).

In the present way, the present technology may limit the functions of a vehicle according to costs and a requirement of a vehicle sharing provider and protect private information related to a vehicle sharing service provider and a vehicle sharing service user by setting a vehicle sharing service mode through an application of a vehicle terminal device or a mobile communication terminal without having to additionally install a separate terminal.

Furthermore, the technology may provide a vehicle sharing service more efficiently by differentially charging a fee according to a convenience specification selected according to a vehicle sharing service user.

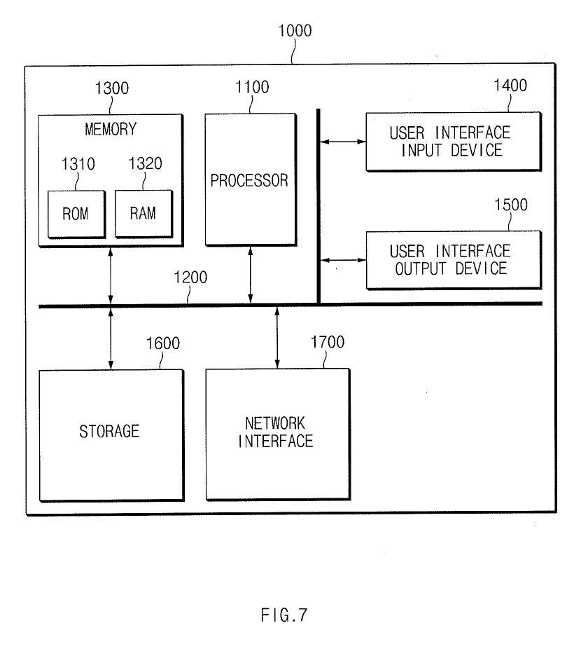

FIG. 7 is a diagram of a computer system to which the method for providing a vehicle sharing service according to an exemplary embodiment of the present invention is applied.

Referring to FIG. 7, the computing system 1000 may include at least one processor 1100 connected through a bus 1200, a memory 1300, a user interface input device 1400, a user interface output device 1500, a storage 1600, and a network interface 1700.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the steps of the method or algorithm described in relation to the exemplary embodiments of the present invention may be implemented directly by hardware executed by the processor 1100, a software module, or a combination thereof. The software module may reside in a storage medium (that is, the memory 1300 and/or the storage 1600) including a RAM memory, a flash memory, a ROM memory, an EPROM memory, an EEPROM memory, a register, a hard disk, a detachable disk, or a CD-ROM.

The exemplary storage medium is coupled to the processor 1100, and the processor 1100 may read information from the storage medium and may write information in the storage medium In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The present technology may limit the functions of a vehicle according to costs and a requirement of a vehicle sharing service provider and protect private information related to a vehicle sharing service provider and a vehicle sharing service user by setting a vehicle sharing service mode through an application of a vehicle terminal device or a mobile communication terminal without having to additionally install a separate terminal.

Furthermore, the technology may provide a vehicle sharing service more efficiently by differentially charging a fee according to a convenience specification selected according to a vehicle sharing service user.

The above description is a simple exemplification of the technical spirit of the present invention, and the present invention may be variously corrected and modified by those skilled in the art to which the present invention pertains without departing from the essential features of the present invention.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the claims appended hereto and their equivalents.

What is claimed is:

1. An apparatus configured for providing a vehicle sharing service, the apparatus comprising:
a reservation device configured to accept a reservation for the vehicle sharing service from a user terminal for use of the vehicle sharing service, to request an approval of the reservation from a provider terminal of a provider of the vehicle, the reservation of which has been accepted, and to, when the approval of the reservation is received from the provider terminal, confirm the reservation; and
a private information protecting device configured to provide a vehicle setting value received from the user terminal to the vehicle, the reservation of which has been accepted, and to request initialization of the vehicle setting value from the vehicle after the use of the vehicle sharing service of the vehicle is completed.

2. The apparatus of claim 1, wherein the private information protecting device includes:
a vehicle setting value transmitting device configured to, when the vehicle setting value is received from the user terminal, transmit the vehicle setting value to the vehicle, the reservation of which has been accepted;
a vehicle setting value initializing device configured to, when the vehicle is returned after the vehicle sharing service is provided through the vehicle, request initialization of the setting of the vehicle setting value and deletion of vehicle sharing service use information; and
a personalization device configured to, when the vehicle is returned, encrypt the vehicle sharing service use information including the vehicle setting value.

3. The apparatus of claim 2, wherein the reservation device includes:
a reservation accepting device configured to, when the request for the reservation for the vehicle sharing service is accepted from the user terminal, receive a use date and a use time from the user terminal;
a vehicle list generating device configured to generate a list of vehicles that is configured to be reserved at the use date and the use time;
a reservation approval requesting device configured to, when one of the vehicles in the list is selected, request an approval of the reservation from the provider terminal of the provider of the selected vehicle; and
a reservation confirming device configured to, when the approval of the reservation is completed, confirm the reservation.

4. The apparatus of claim 1, further including:
a charging policy device configured to determine costs for the vehicle sharing service according to the vehicle setting value.

5. The apparatus of claim 2, wherein the vehicle sharing service use information includes at least one of a vehicle setting value, user information, vehicle driving information, total driving distance information, and reservation time information,
wherein the user information includes at least one of a name and driving license information related to a user who reserved the vehicle sharing service, and
wherein the vehicle driving information includes at least one of a vehicle driving route and accident location information, and
wherein the reservation time information includes at least one of a rent time, a reservation start time, a reservation expiration time, and a vehicle return time.

6. The apparatus of claim 5, wherein the personalization device provides, among the vehicle sharing service use information, the user information, the vehicle setting value, and the reservation time information to the provider terminal, and does not provide the vehicle driving information and a total driving distance information to the provider terminal.

7. The apparatus of claim 1, further including:
a monitoring device configured to, when the vehicle sharing service is provided through the vehicle, monitor a vehicle driving item.

8. The apparatus of claim 7, wherein the monitoring device is configured to monitor whether the vehicle that provides the vehicle sharing service encounters an accident, and transmits the user information and the vehicle driving information to the provider terminal when the vehicle encounters the accident.

9. The apparatus of claim 7, wherein the monitoring device identifies whether the user is in the vehicle when a reservation start time of the vehicle comes, and identifies whether the vehicle is returned when a reservation expiration time of the vehicle comes.

10. The apparatus of claim 9, further including:
a notification device configured to transmit a notification notifying whether the user is in the vehicle to the provider terminal after the reservation start time of the vehicle comes, and to transmit a notification to the provider terminal when an accident occurs during driving of the vehicle or the vehicle is not returned even though the reservation expiration time of the vehicle comes.

11. The apparatus of claim 1, wherein the vehicle setting value is a setting value of at least one of an occupant classification system (OCS), a side airbag, a heating wire sheet, a steering wheel heater, a riding posture memory system, a Hi-Pass system, a head-up display, a parking assistant system, an around view monitoring (AVM) device, a portable phone wireless charging system, a blue link, an adaptive control suspension, a drive mode (eco/normal/sport), a rear warning system, an advanced smart cruise control (ASCC), an HAD highway driving support system, and a lane keeping assist system (LKAS).

12. The apparatus of claim 1, wherein the user terminal or the provider terminal includes a mobile communication terminal or a vehicle terminal mounted in the vehicle.

13. A system for providing a vehicle sharing service, the system comprising:
a processor configured to accept a reservation for the vehicle sharing service from a user terminal for use of the vehicle sharing service, and to, when an approval of the reservation is received from a provider terminal of a provider of a vehicle, the reservation of which has been accepted, confirm the reservation, to transmit a vehicle setting value received from the user terminal to the vehicle, the reservation of which has been accepted, to, when the vehicle is returned after the vehicle sharing service is provided through the vehicle, request initialization of the setting of the vehicle setting value and deletion of vehicle sharing service use information, and to encrypt the vehicle sharing service use information including the vehicle setting value; and
a storage configured to store the encrypted vehicle sharing service use information for users.

14. The system of claim 13, wherein the processor includes:
a reservation device configured to accept the reservation for the vehicle sharing service from the user terminal for use of the vehicle sharing service, to request an approval of the reservation from the provider terminal of the provider of the vehicle, the reservation of which has been accepted, and to when the approval of the reservation is received from the provider terminal, confirm the reservation;
a vehicle setting value transmitting device configured to, when the vehicle setting value is received from the user terminal, transmit the vehicle setting value to the vehicle, the reservation of which has been accepted;
a vehicle setting value initializing device configured to, when the vehicle is returned after the vehicle sharing service is provided through the vehicle, request initialization of the setting of the vehicle setting value and deletion of vehicle sharing service use information;
a charging policy device configured to determine costs for the vehicle sharing service according to the vehicle setting value; and
a personalization device configured to, when the vehicle is returned, encrypt the vehicle sharing service use information.

15. The system of claim 14, further including:
a communication device configured to perform communication with the user terminal or the provider terminal; and
an authentication device configured to perform authentication when a request for login is made by the user terminal or the provider terminal.

16. A method for providing a vehicle sharing service, the method comprising:
accepting a reservation for the vehicle sharing service from a user terminal of a vehicle sharing user for a vehicle;
requesting an approval of a reservation from a provider terminal of a provider, the reservation of which has been accepted;
when the approval of the reservation is received from the provider terminal, transmitting a vehicle setting value to the vehicle, the reservation of which has accepted;
when the vehicle is returned after the vehicle sharing service is provided through the vehicle, requesting initialization of the setting of the vehicle setting value and deletion of vehicle sharing service use information; and
storing the vehicle sharing service use information including the vehicle setting value for users.

17. The method of claim 16, further including:
when a request for login is made by an application executed in the user terminal, performing authentication.

18. The method of claim 16, further including:
storing vehicle sharing service use information including the vehicle setting value for users; and
encrypting and storing the vehicle sharing service use information.

19. The method of claim 16, wherein the accepting of the reservation for the vehicle sharing service includes:
when the request for the reservation of the vehicle sharing service is accepted from the user terminal, receiving a use date and a use time from the user terminal and generating a list of vehicles that are configured to be reserved at the use date and the use time;
providing the list of the vehicles to the user terminal; and
selecting a vehicle by the user terminal and receiving the vehicle setting value.

20. The method of claim 18, further including:
determining costs for the vehicle sharing service according to the vehicle setting value.

21. The method of claim 20, further including:
when the reservation is confirmed, requesting payment of costs from the user terminal.

22. The method of claim 21, further including:
when the vehicle sharing service is provided through the vehicle, monitoring a vehicle driving item.

23. The method of claim 22, wherein the monitoring of the vehicle driving item includes:
when the vehicle encounters an accident, transmitting use information and vehicle driving information to the provider terminal.

24. The method of claim 16, wherein the vehicle sharing service use information includes at least one of a vehicle setting value, user information, vehicle driving information, total driving distance information, and reservation time information,
wherein the user information includes at least one of a name of a user who reserved the vehicle sharing service and driving license information,
wherein the vehicle driving information includes at least one of a vehicle driving route and accident location information, and
wherein the reservation time information includes at least one of a rent time, a reservation start time, a reservation expiration time, and a vehicle return time.

25. The method of claim 24, wherein among the vehicle sharing service use information, the user information, the vehicle setting value, and the reservation time information are provided to the provider terminal, and the vehicle driving information and a total driving distance information are not provided to the provider terminal.
